(19) United States
(12) Patent Application Publication
(10) Pub. No.: US 2005/0241744 A1
(43) Pub. Date: Nov. 3, 2005

(54) METHOD FOR INSTALLING A BATHTUB LINER USING URETHANE FOAM

(75) Inventor: Mark Wayne Domanico, Naperville, IL (US)

Correspondence Address: FACTOR & LAKE, LTD, 1327 W. WASHINGTON BLVD., SUITE 5G/H, CHICAGO, IL, 60607, US

(73) Assignee: LUXURY BATH SYSTEMS, INC., Glendale Heights, IL (US)

(21) Appl. No.: 10/709,383

(22) Filed: Apr. 30, 2004

(51) Int. Cl. B32B 31/00

(52) U.S. Cl. 156/78; 156/212; 156/293

(57) ABSTRACT

A method for adhering a bathtub liner to an existing bathtub. The method includes the steps of providing a suitably sized liner for an existing bathtub, applying urethane foam to at least a portion of a bottom surface of at least one of the bathtub and the suitably sized liner, positioning the liner in the bathtub such that the liner substantially follows contours of the existing bathtub, and applying pressure to the bathtub liner to affix the liner to the bathtub.

### BACKGROUND OF INVENTION

1. Field of the Invention

The present invention relates to a method for installing a bathtub liner using urethane foam.

2. Background Art

Bathtub replacement and/or remodeling has long been known in the art. Due to the costs involved with the replacement of bathtubs, alternatives have been developed. Included in these alternatives is the use of a liner (or cover) which fits over an existing bathtub thereby eliminating the cost of removing the existing bathtub.

While the use of bathtub liners has provided an attractive alternative to bathtub replacement, there are nevertheless drawbacks in the installation of new liners to existing tubs. For example, one common installation method requires the use of multiple layers of butyl tape and silicone to affix the liner to the existing tub and to fill in dead space between the liner and existing tub. Unfortunately, the use of butyl tape and silicone is very costly, as many as 4 layers of butyl tape and 12 tubes of silicone may be required, and time-consuming, due to the need to cure the materials.

Additionally, with the use of butyl tape/silicone, a number of air pockets will unavoidably form between the liner and bathtub after installation. These air pockets enable moisture to accumulate in the space between the liner and bathtub. In these pockets, mold can form and produce unpleasant odors which can only be extinguished by completely removing the liner and reapplying the butyl tape and silicone. Additionally, the butyl tape/silicone can lose its adhesive properties due to the moisture and as a result, the liner will undesirably shift when used. Further, the air pockets can create a “spring-like” feel to the bathtub which is uncomfortable to the user.

Furthermore, neither butyl tape nor silicone are particularly good insulators of heat. Therefore, any person who desires a warm bath in such a tub will be rather displeased to find the water temperature may quickly cool due to the poor insulation of the butyl tape and silicone.

Thus, it is an object of the invention to provide a method of installing a bathtub liner to an existing tub which is less costly, less time-consuming, and more efficient than known methods, and which results in an installed bathtub liner having minimal, if any, air pockets beneath the liner.

These and other objectives will become apparent in light of the specification and claims appended hereto

### SUMMARY OF INVENTION

The present invention is a method of installing a bathtub liner to an existing tub which is less costly, less time-consuming, and more efficient than known methods, and which results in an installed bathtub liner having minimal, if any, air pockets beneath the liner. In comparison to known methods, the present invention saves the installer a significant amount of time and expense, as well as substantially reduces the likelihood of slippage, mold growth, heat loss, and other problems typically associated with known methods of installing a liner to an existing tub.

The preferred method includes the steps of:
a) providing a suitably sized liner for an existing bathtub;
b) applying urethane foam to at least a portion of a bottom surface of at least one of the bathtub and the suitably sized liner;
c) positioning the liner in the bathtub such that the liner substantially follows contours of the existing bathtub; and
d) applying pressure to the liner to affix the liner to the bathtub.

Preferably, the existing bathtub is constructed from cast iron or pressed metal, but may be any other material compatible with urethane foam and silicone. The urethane foam is preferably flexible and expandable, and is preferably applied to a portion of a bottom surface of the bathtub or suitably sized liner via pouring, spraying, or any other suitable means. In a preferred embodiment, the urethane foam is coated on substantially all of a bottom surface of the liner or bathtub.

Prior to or subsequent to affixing the liner to the bathtub, apertures may be cut into the liner as desired to correspond to the desired positioning of any existing article in the bathtub such as a soap dish or drain. Further, once installed, any visible areas between the bathtub and the liner can be caulked for aesthetic purposes with caulk, silicone, or any suitable material.

The step of positioning the liner in the bathtub such that the liner substantially follows contours of the existing bathtub may include the step of providing a liner which is pre-formed to fit the contours of the existing bathtub.

In another embodiment, the step of positioning the liner in the bathtub such that the liner substantially follows contours of the existing bathtub preferably includes the step of deforming a liner into a shape which substantially matches contours of the existing bathtub via at least one of heat, positive pressure, and negative pressure.

### BRIEF DESCRIPTION OF DRAWINGS

FIG. 1 of the drawings is a top perspective view of the present invention; and

FIG. 2 of the drawings is another top perspective view of the present invention.

### DETAILED DESCRIPTION

While this invention is susceptible of embodiment in many different forms, there is shown in the drawings and will be described in detail, one specific embodiment with the understanding that the present disclosure is to be considered as an exemplification of the principles of the invention and is not intended to limit the invention to the embodiment illustrated.

The installation of new top liners to existing bathtubs is well-known in the art. Such liners are regularly installed to existing bathtubs to produce a “new bathroom” look without completely removing the former tub. The alternative, removing the existing bathtub, necessitates structurally damaging the floors and walls, all which add expense and time.

A new method for installing a liner to an existing bathtub using urethane foam is disclosed which is more cost-effective, less time-consuming, and more efficient than known methods, and which results in an installed bathtub liner having minimal, if any, air pockets beneath the liner. The method primarily uses urethane foam which enables adhesion of the liner to the bathtub in a single application of the urethane foam. The result is substantial savings in materials, cost, and installation time. Further, the urethane foam has flexible, expansive qualities such that substantially all dead space between the liner and existing tub is filled. The result is an installed liner which feels secure and is not likely to shift during use. Further, with little dead space, moisture is unlikely to accumulate between the liner and tub after installation. The result is the adhesive properties of the urethane foam are maintained over time and the problem of mold formation is unlikely to occur. Lastly, urethane foam is a better insulator than butyl tape and/or silicone, therefore, water temperature will be more stable through the use of urethane foam.

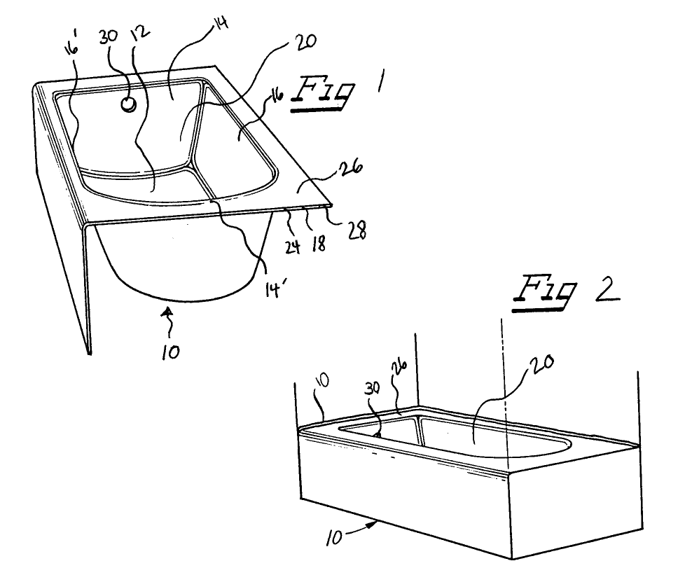

Referring now to the drawings, existing bathtub 10 has bottom surface 12 and walls 14, 14′, 16, 16′ and outer rim 18 which define cavity 20 and contours 22 as shown in FIGS. 1-2. The outer rim has top surface 24. The bathtub is preferably cast iron or pressed metal for optimum adhesion of the urethane foam. Any other bathtub material which is compatible with urethane foam may similarly be used.

Liner 26 has bottom surface 28 and may be any type of material used in the remodeling of existing bathtubs. The liner is preferably pre-formed at a remote location to substantially follow the contours of the bathtub to which the liner will be adhered. In another embodiment, the liner can be deformed in situ in the shape of the existing bathtub. The deformed liner can be affixed to the existing bathtub simultaneously with deformation of the liner, or alternatively after deformation of the liner.

The urethane foam is preferably polyurethane foam which is of the expandable and flexible type; however, it is contemplated that any other urethane material which has adhesive and expansion properties may be used.

To install a liner as shown in FIGS. 1-2, suitably sized liner 26 is first provided for existing bathtub 10. The liner is selectively pre-formed at a remote location or may be deformed it situ at the site of the new liner installation. The urethane foam is coated on bottom surface 28 of liner 26 or on bottom surface 12 of the existing bathtub. The urethane foam may be applied to the bottom surface of the liner or bottom surface of the bathtub by spraying, pouring, brushing, or any other suitable means. Preferably, the urethane foam is applied to substantially all of the bottom surface of the liner or bathtub. The liner is then lowered into the bathtub via any suitable means, and is positioned in the bathtub such that the liner substantially follows contours 22 of the existing bathtub. The installer may then determine if any dead space remains between liner 26 and bathtub 10. If so, the installer may use additional urethane foam as needed. To affix the liner to the bathtub, pressure is applied to the bathtub liner to adhere the liner to the bathtub.

In one embodiment, the bathtub liner is affixed to the existing bathtub via negative pressure as would be understood to one of ordinarily skill in the art. In yet another embodiment, heat and positive pressure are used to secure the new liner to the existing bathtub liner as would be understood by one of ordinary skill in the art.

It is contemplated that the liner may be formed in situ at the site of installation. As such, the shape of the liner may be formed in the same step as the step of permanently affixing the liner to the bathtub. Thus, the formed liner need not be removed if so desired. Specifically, in this embodiment of the method, urethane foam is applied to the bathtub as described above. The unformed liner is placed over the top of the bathtub. Subsequently, the liner is drawn to the existing bathtub and deforms to substantially match the contours of the bathtub over the applied urethane foam/silicone. Because the urethane foam has already been applied, the liner is also fully adhered to the bathtub when the liner is deformed. It is contemplated that the liner may be drawn to the bathtub via vacuum pressure or positive pressure and/or heat as would be understood by one of ordinary skill in the art.

Further, as shown in FIGS. 1-2, apertures 30 may be cut into the liner as needed prior to the adhering process or thereafter which correspond to the desired positioning of any existing article in the bathtub such as a soap dish, over flow drain, or drain. Further, once installed, any visible areas between the bathtub and the liner may be caulked for aesthetic purposes with silicone, caulk, or any other suitable material.

The foregoing description merely explains and illustrates the invention and the invention is not limited thereto except insofar as the appended claims are so limited, as those skilled in the art that have the disclosure before them will be able to make modifications without departing from the scope of the invention.

1. A method for adhering a bathtub liner to an existing bathtub comprising the steps of:
providing a suitably sized liner for an existing bathtub;
applying urethane foam to at least a portion of a bottom surface of at least one of the bathtub and the suitably sized liner;
positioning the liner in the bathtub such that the liner substantially follows contours of the existing bathtub; and
applying pressure to the bathtub liner to affix the liner to the bathtub.

2. The method according to claim 1, wherein the existing bathtub is constructed from at least one of cast iron and pressed metal.

3. The method according to claim 1, wherein the urethane foam is expandable and flexible.

4. The method according to claim 1, wherein the step of applying urethane foam to at least a portion of a bottom surface of at least one of the bathtub and the suitably sized liner includes the step of spraying urethane foam on at least a portion of a bottom surface of at least one of the bathtub and the suitably sized liner.

5. The method according to claim 1, wherein the step of applying urethane foam to at least a portion of a bottom surface of at least one of the bathtub and the suitably sized liner includes the step of pouring urethane foam on at least a portion of a bottom surface of at least one of the bathtub and the suitably sized liner.

6. The method according to claim 1, wherein the step of applying urethane foam to at least a portion of a bottom surface of at least one of the bathtub and the suitably sized liner includes the step of applying urethane foam to substantially all of a bottom surface of at least one of the bathtub and the suitably sized liner.

7. The method according to claim 1, further including the step of aligning openings in the liner to correspond to the desired positioning of at least one of an overflow opening, a drain, and a soap dish.

8. The method according to claim 1, further including the step of caulking any visible space between the bathtub and the liner.

9. The method according to claim 1, wherein the step of positioning the liner in the bathtub such that the liner substantially follows contours of the existing bathtub includes the step of providing a liner which is preformed to fit the contours of the existing bathtub.

10. The method according to claim 1, wherein the step of positioning the liner in the bathtub such that the liner substantially follows contours of the existing bathtub includes the step of deforming a liner into a shape which substantially matches contours of the existing bathtub via at least one of heat, positive pressure, and negative pressure.
